(19) United States
(12) Patent Application Publication
(10) Pub. No.: US 2009/0064258 A1
(43) Pub. Date: Mar. 5, 2009

(54) System and Method for Sending and Receiving Text Messages via a Set Top Box

(75) Inventors: David Mornhineway, San Antonio, TX (US); Carlton Ligar Brown, San Antonio, TX (US)

Correspondence Address: AT&T Legal Department, Attn: Patent Docketing, Attn: Patent Docketing Room 2A- 207, One AT & T Way, Bedminster, NJ, 07921, US

(73) Assignee: AT&T KNOWLEDGE VENTURES, LP, Reno, NV (US)

(21) Appl. No.: 11/845,577

(22) Filed: Aug. 27, 2007

(51) Int. Cl. H04N 7/173

(52) U.S. Cl. 725/131

(57) ABSTRACT

A method for sending text messages from an IPTV receiver is disclosed and includes detecting that a text button is pressed at an IPTV remote control device associated with the IPTV receiver and displaying a text window at a display device coupled to the IPTV receiver. Text messages can be sent and received via the text window.

### FIELD OF THE DISCLOSURE

The present disclosure relates generally to set top boxes.

### BACKGROUND

Television viewing is a popular form of entertainment. Developments in television and video technologies allow viewers to watch a wide variety of high-resolution content and to record programs to watch at a convenient time. Recent advancements, such as video-on-demand and the expansion of available channels, add to the breadth and convenience of television programming. In additional to increased video functionality, a set top box can be used as a communication device.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram illustrating an embodiment of an Internet protocol television (IPTV) system;

FIG. 2 is a front plan view of a video monitoring system;

FIG. 3 is a rear plan view of the video monitoring system;

FIG. 4 is a plan view of a remote control device;

FIG. 5 is a flow chart illustrating a method of sending text messages from a set top box;

FIG. 6 is a flow chart illustrating a method of receiving text messages at a set top box; and

FIG. 7 is a block diagram of an illustrative embodiment of a general computer system.

The use of the same reference symbols in different drawings indicates similar or identical items.

### DETAILED DESCRIPTION OF THE DRAWINGS

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily delimit any of the various claimed inventions. Moreover, some statements may apply to some inventive features but not to others.

In a particular embodiment, a method for sending text messages from an IPTV receiver is disclosed and includes detecting that a text button is pressed at an IPTV remote control device associated with the IPTV receiver and displaying a text window at a display device coupled to the IPTV receiver. Text messages can be sent and received via the text window.

In another embodiment, an IPTV receiver is disclosed and can include a processor and a memory coupled to the processor. A computer program can be stored within the memory and the computer program can include logic to detect when a text button is pressed at an IPTV remote control device associated with the IPTV receiver and logic to display a text window at a display device coupled to the IPTV receiver.

In another embodiment, a graphical user interface (GUI) for sending text via an IPTV receiver is disclosed and can include a text window for viewing text messages. The text window can be displayed at display device coupled to the IPTV receiver. The GUI can also include a virtual keyboard, wherein the virtual keyboard is displayed at the display device.

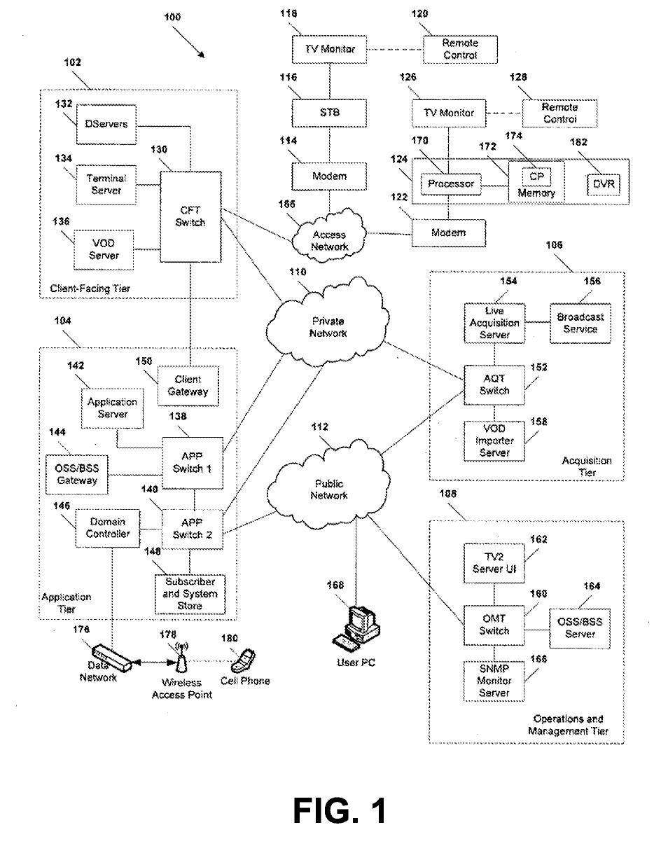

FIG. 1 shows an IPTV system 100 including a client facing tier 102, an application tier 104, an acquisition tier 106, and an operations and management tier 108. Each tier 102, 104, 106, and 108 is coupled to one or both of a private network 110 and a public network 112. For example, the client-facing tier 102 can be coupled to the private network 110, while the application tier 104 can be coupled to the private network 110 and to a public network such as the Internet. The acquisition tier 106 can also be coupled to the private network 110 and to the public network 112. Moreover, the operations and management tier 108 can be coupled to the public network 112.

The various tiers 102, 104, 106 and 108 communicate with each other via the private network 110 and the public network 112. For instance, the client-facing tier 102 can communicate with the application tier 104 and the acquisition tier 106 via the private network 110. The application tier 104 can also communicate with the acquisition tier 106 via the private network 110. Further, the application tier 104 can communicate with the acquisition tier 106 and the operations and management tier 108 via the public network 112. Moreover, the acquisition tier 106 can communicate with the operations and management tier 108 via the public network 112. In a particular embodiment, elements of the application tier 104 can communicate directly with the client-facing tier 102.

The client-facing tier 102 can communicate with user equipment via a private access network 166, such as an Internet Protocol Television (IPTV) network. In an illustrative embodiment, modems such as a first modem 114 and a second modem 122 can be coupled to the private access network 166. The client-facing tier 102 can communicate with a first representative set-top box device 116 via the first modem 114 and with a second representative set-top box device 124 via the second modem 122. The client-facing tier 102 can communicate with a large number of set-top boxes over a wide geographic area, such as a regional area, a metropolitan area, a viewing area, or any other suitable geographic area that can be supported by networking the client-facing tier 102 to numerous set-top box devices. In one embodiment, the client-facing tier 102 can be coupled to the modems 114 and 122 via fiber optic cables. Alternatively, the modems 114 and 122 can be digital subscriber line (DSL) modems that are coupled to one or more network nodes via twisted pairs, and the client-facing tier 102 can be coupled to the network nodes via fiber-optic cables. Each set-top box device 116 and 124 can process data received from the private access network 166 via an IPTV software platform such as Microsoft® TV IPTV Edition.

The first set-top box device 116 can be coupled to a first display device 118, such as a first television monitor, and the second set-top box device 124 can be coupled to a second display device 126, such as a second television monitor. Moreover, the first set-top box device 116 can communicate with a first remote control 120, and the second set-top box device can communicate with a second remote control 128. In an exemplary, non-limiting embodiment, each set-top box device 116 and 124 can receive data or video from the client-facing tier 102 via the private access network 166 and render or display the data or video at the display device 118 or 126 to which it is coupled. The set-top box devices 116 and 124 thus may include tuners that receive and decode television programming information for transmission to the display devices 118 and 126. Further, the set-top box devices 116 and 124 can include an STB processor 170 and an STB memory device 172 that is accessible to the STB processor. In a particular embodiment, the set-top box devices 116 and 124 can also communicate commands received from the remote controls 120 and 128 back to the client-facing tier 102 via the private access network 166.

In an illustrative embodiment, the client-facing tier 102 can include a client-facing tier (CFT) switch 130 that manages communication between the client-facing tier 102 and the private access network 166 and between the client-facing tier 102 and the private network 110. As shown, the CFT switch 130 is coupled to one or more data servers 132 that store data transmitted in response to user requests, such as video-on-demand material. The CFT switch 130 can also be coupled to a terminal server 134 that provides terminal devices, such as a game application server and other devices with a common connection point to the private network 110. In a particular embodiment, the CFT switch 130 can also be coupled to a video-on-demand (VOD) server 136.

The application tier 104 can communicate with both the private network 110 and the public network 112. In this embodiment, the application tier 104 can include a first application tier (APP) switch 138 and a second APP switch 140. In a particular embodiment, the first APP switch 138 can be coupled to the second APP switch 140. The first APP switch 138 can be coupled to an application server 142 and to an OSS/BSS gateway 144. The application server 142 provides applications to the set-top box devices 116 and 124 via the private access network 166, so the set-top box devices 116 and 124 can provide functions such as display, messaging, processing of IPTV data and VOD material. In a particular embodiment, the OSS/BSS gateway 144 includes operation systems and support (OSS) data, as well as billing systems and support (BSS) data.

The second APP switch 140 can be coupled to a domain controller 146 that provides web access, for example, to users via the public network 112. The second APP switch 140 can be coupled to a subscriber and system store 148 that includes account information, such as account information that is associated with users who access the system 100 via the private network 110 or the public network 112. In a particular embodiment, the application tier 104 can also include a client gateway 150 that communicates data directly to the client-facing tier 102. In this embodiment, the client gateway 150 can be coupled directly to the CFT switch 130. The client gateway 150 can provide user access to the private network 110 and the tiers coupled thereto.

In a particular embodiment, the set-top box devices 116 and 124 can access the system via the private access network 166 using information received from the client gateway 150. The private access network 166 provides security for the private network 110. User devices can access the client gateway 150 via the private access network 166, and the client gateway 150 can allow such devices to access the private network 110 once the devices are authenticated or verified. Similarly, the client gateway 150 can prevent unauthorized devices, such as hacker computers or stolen set-top box devices from accessing the private network 110, by denying access to these devices beyond the private access network 166.

For example, when the set-top box device 116 accesses the system 100 via the private access network 166, the client gateway 150 can verify subscriber information by communicating with the subscriber and system store 148 via the private network 110, the first APP switch 138 and the second APP switch 140. Further, the client gateway 150 can verify billing information and status by communicating with the OSS/BSS gateway 144 via the private network 110 and the first APP switch 138. The OSS/BSS gateway 144 can transmit a query across the first APP switch 138, to the second APP switch 140, and the second APP switch 140 can communicate the query across the public network 112 to the OSS/BSS server 164. After the client gateway 150 confirms subscriber and/or billing information, the client gateway 150 can allow the set-top box device 116 access to IPTV content and VOD content. If the client gateway 150 cannot verify subscriber information for the set-top box device 116, such as because it is connected to a different twisted pair, the client gateway 150 can deny transmissions to and from the set-top box device 116 beyond the private access network 166.

The acquisition tier 106 includes an acquisition tier (AQT) switch 152 that communicates with the private network 110. The AQT switch 152 can also communicate with the operations and management tier 108 via the public network 112. In a particular embodiment, the AQT switch 152 can be coupled to a live acquisition server 154 that receives television content, for example, from a broadcast service 156. Further, the AQT switch can be coupled to a video-on-demand importer server 158 that stores television content received at the acquisition tier 106 and communicate the stored content to the client-facing tier 102 via the private network 110.

The operations and management tier 108 can include an operations and management tier (OMT) switch 160 that conducts communication between the operations and management tier 108 and the public network 112. In the illustrated embodiment, the OMT switch 160 is coupled to a TV2 server 162. Additionally, the OMT switch 160 can be coupled to an OSS/BSS server 164 and to a simple network management protocol (SNMP) monitor 166 that monitors network devices. In a particular embodiment, the OMT switch 160 can communicate with the AQT switch 152 via the public network 112.

In a particular embodiment during operation of the IPTV system, the live acquisition server 154 can acquire television content from the broadcast service 156. The live acquisition server 154 in turn can transmit the television content to the AQT switch 152 and the AQT switch can transmit the television content to the CFT switch 130 via the private network 110. Further, the television content can be encoded at the D-servers 132, and the CFT switch 130 can communicate the television content to the modems 114 and 122 via the private access network 166. The set-top box devices 116 and 124 can receive the television content from the modems 114 and 122, decode the television content, and transmit the content to the display devices 118 and 126 according to commands from the remote control devices 120 and 128.

Additionally, at the acquisition tier 106, the video-on-demand (VOD) importer server 158 can receive content from one or more VOD sources outside the IPTV system 100, such as movie studios and programmers of non-live content. The VOD importer server 158 can transmit the VOD content to the AQT switch 152, and the AQT switch 152 in turn can communicate the material to the CFT switch 130 via the private network 110. The VOD content can be stored at one or more servers, such as the VOD server 136.

When a user issues a request for VOD content to the set-top box device 116 or 124, the request can be transmitted over the private access network 166 to the VOD server 136 via the CFT switch 130. Upon receiving such a request, the VOD server 136 can retrieve requested VOD content and transmit the content to the set-top box device 116 or 124 across the private access network 166 via the CFT switch 130. In an illustrative embodiment, the live acquisition server 154 can transmit the television content to the AQT switch 152, and the AQT switch 152 in turn can transmit the television content to the OMT switch 160 via the public network 112. In this embodiment, the OMT switch 160 can transmit the television content to the TV2 server 162 for display to users accessing the user interface at the TV2 server. For example, a user can access the TV2 server 162 using a personal computer 168 coupled to the public network 112.

The domain controller 146 communicates with the public network 112 via the second APP switch 140. Additionally, the domain controller 146 can communicate via the public network 112 with the personal computer 168. For example, the domain controller 146 can display a web portal via the public network 112 and allow users to access the web portal using the PC 168. Further, in an illustrative embodiment, the domain controller 146 can communicate with at least one wireless network access point 178 over a data network 176. In this embodiment, each wireless network access device 178 can communicate with user wireless devices such as a cellular telephone 180.

In a particular embodiment, the set-top box devices can include an STB computer program 174 that is embedded within the STB memory device 172. The STB computer program 174 can contain instructions to receive and execute at least one user television viewing preference that a user has entered by accessing an Internet user account via the domain controller 146. For example, the user can use the PC 168 to access a web portal maintained by the domain controller 146 via the Internet. The domain controller 146 can query the subscriber and system store 148 via the private network 110 for account information associated with the user. In a particular embodiment, the account information can associate the user's Internet account with the second set-top box device 124. For instance, in an illustrative embodiment, the account information can relate the user's account to the second set-top box device 124 by associating the user account with an IP address of the second set-top box device, with data relating to one or more twisted pairs connected with the second set-top box device, with data related to one or more fiber optic cables connected with the second set-top box device, with an alphanumeric identifier of the second set-top box device, with any other data that is suitable for associating second set-top box device with a user account, or with any combination of these. Further details of the IPTV system are taught in U.S. Patent Application Publication No. 2007/0083895, the disclosure of which is hereby incorporated by reference.

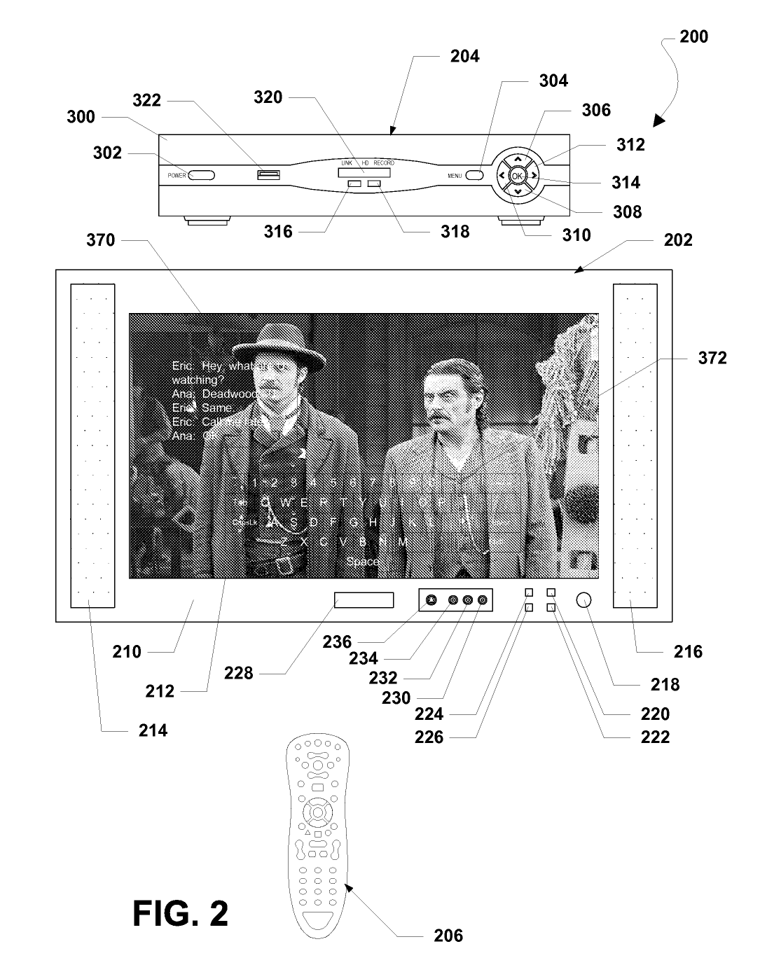

FIG. 2 shows a video system 200 that can be used in conjunction with the system 100 above. The video system 200 can include a display device 202, an IPTV receiver set top box 204, and a remote control device 206. In a particular embodiment, the display device 202 can be a television. The display device 202 can include a front panel 210 in which a display screen 212 is incorporated. The front panel 210 can also include a first speaker 214 and a second speaker 216. Moreover, the front panel 210 can include a power button 218, a channel up button 220, a channel down button 222, a volume up button 224, and a volume down button 226.

The display device 202 can include a receiver 228 incorporated therein. The receiver 228 can be an infrared (IR) receiver, a radio frequency (RF) receiver, or a similar receiver. FIG. 2 also indicates that the front panel 210 of the display device 202 can include a right channel RCA connector 230, a left channel RCA connector 232, and a composite video RCA connector 234. Additionally, the front panel 210 can include an S-video connector 236.

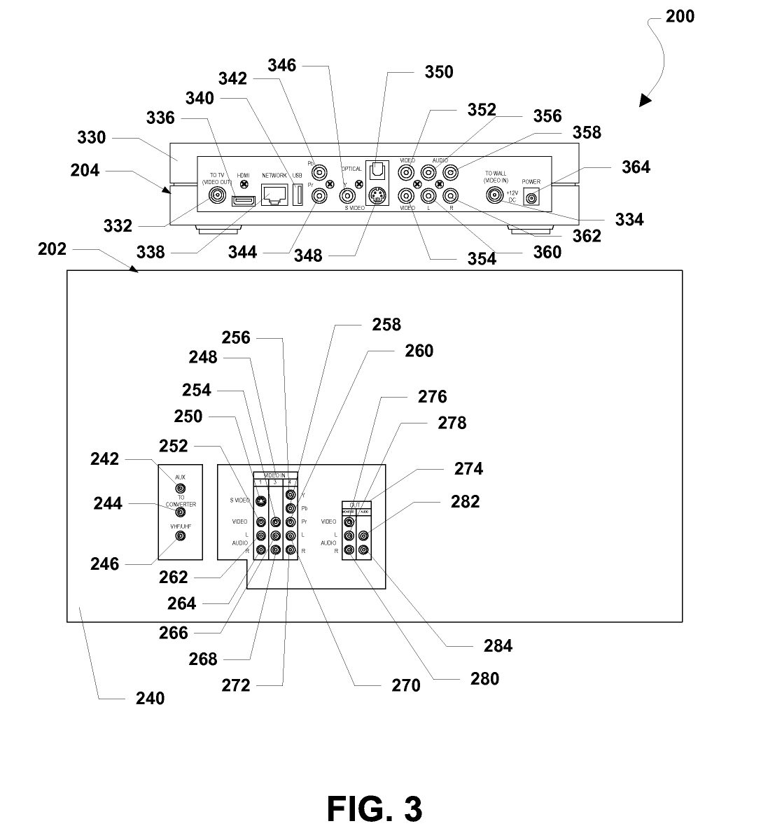

FIG. 3 shows that the display device 202 can also include a rear panel 240. The rear panel 240 can include a plurality of connectors incorporated therein. For example, the rear panel 240 of the display device 202 can include a first RF connector 242, a second RF connector 244, and a third RF connector 246. The rear panel 240 can also include a video in panel 248. The video in panel 248 can include an S-video connector 250, a first composite video RCA connector 252, and a second composite video RCA connector 254. The video in panel 248 can also include a Y component RCA connector 256, a Pb component RCA connector 258, and a Pr component RCA connector 260. Further, the video in panel 248 can include a first left channel RCA connector 262, a first right channel RCA connector 264, a second left channel RCA connector 266, a second right channel RCA connector 268, a third left channel RCA connector 270, and a third right channel RCA connector 272.

The rear panel 240 can include a video out panel 274. The video out panel 274 can include a composite video RCA connector 276, a first left channel RCA connector 278, a first right channel RCA connector 280, a second left channel RCA connector 282, and a second right channel RCA connector 284.

FIG. 2 shows that the IPTV receiver 204 can include a front panel 300. The front panel 300 of the IPTV receiver 204 can include a power button 302, a menu button 304, an up button 306, a down button 308, a left button 310, a right button 312, and an ok button 314. The front panel 300 of the IPTV receiver 204 can also include a transmitter 316 and a receiver 318 incorporated therein. In a particular embodiment, the transmitter 316 can be an IR transmitter, a RF transmitter, or a similar transmitter. Further, the receiver 318 can be an IR receiver, a RF receiver, or a similar receiver. FIG. 2 also indicates that the front panel 300 of the IPTV receiver 204 can include a display 320 and a universal serial bus (USB) connector 322. The display 320 can be a light emitting diode (LED) display, a liquid crystal display (LCD), or some other display.

FIG. 3 shows that the IPTV receiver 204 can include a rear panel 330. The rear panel 330 of the IPTV receiver 204 can include a first RF connector 332 and a second RF connector 334. Further, the rear panel 330 of the IPTV receiver 204 can include a high definition multi-media interface (HDMI) connector 336, a network connection 338, and a USB connection 340. In a particular embodiment, the network connection 338 can be an RJ-45 port. The network connection 338 can allow the IPTV receiver 204 to be connected to an IPTV network via an Ethernet cable.

The rear panel 330 of the IPTV receiver 204 can also include a Pb component RCA connector 342, a Pr component RCA connector 344, and a Y component RCA connector 346. The rear panel 330 can include an S-video connector 348 and an optical video connector 350. Additionally, the rear panel 330 of the IPTV receiver 204 can include a first composite video RCA connector 352, and a second composite video RCA connector 354. Further, the rear panel 330 of the IPTV receiver 204 can include a first left channel RCA connector 356, a first right channel RCA connector 358, a second left channel RCA connector 360, and a second right channel RCA connector 362. The rear panel 330 of the IPTV receiver 204 can also include a power input connector 364.

FIG. 2 shows that a text messaging window 370 can be presented at the display device 202 by the IPTV receiver 204 when a message is received at the IPTV receiver 204 or when a user chooses to send a text message via the IPTV receiver 204 and the remote control device 206, as described herein. As shown, the text messaging window 370 can be a substantially clear, or transparent, window that overlays the TV content at the display device 202 in order to minimize blocking the TV content. The text that appears in the text messaging window can be opaque.

Alternatively, the text messaging window 370 can be a separate picture-in-picture window that can overlay and block the TV content at the display device 202. In still another embodiment, when sending or receiving text messages via the IPTV receiver 204 the TV display area can be resized and an L shaped bar can flank the TV display area to the bottom and left. The L bar area can be used to view text messages as they are sent and received.

FIG. 2 shows that a virtual keyboard 372 can be presented to a user when the user wishes to send a text message. The virtual keyboard 372 can be navigated using the remote control device 206. The virtual keyboard 372 can overlay the TV content at the display device 202. Further, the virtual keyboard 372 can be substantially clear, or transparent, in order to minimize blockage of the TV content. Specifically, the buttons of the virtual keyboard 372 can be clear and surrounded by an opaque border. Further, the button identifiers can be opaque.

Alternatively, the virtual keyboard 372 can be presented in an L bar, described above. In such an embodiment, the virtual keyboard 372 can be presented in the longer portion of the L bar, e.g., beneath the resized television content.

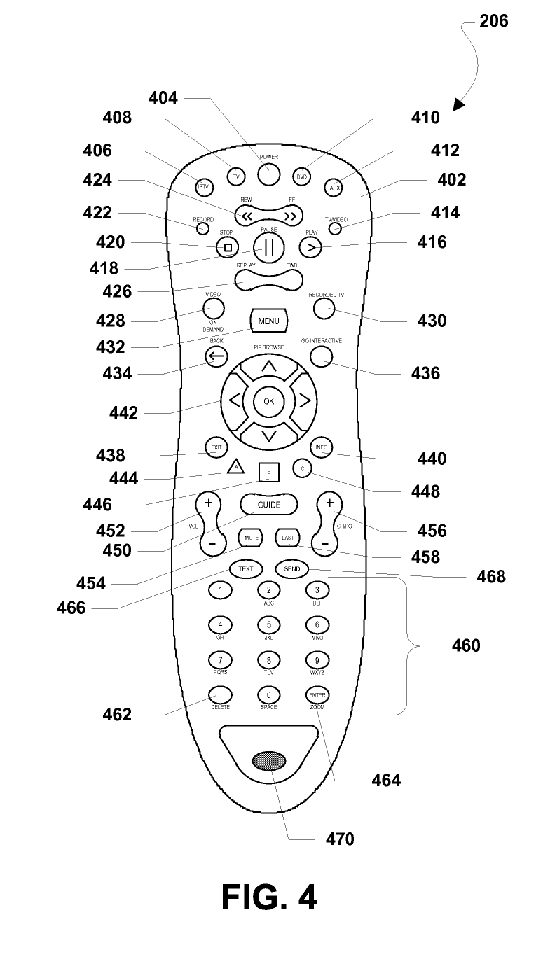

FIG. 4 shows details concerning the remote control device 206. The remote control device 206 can include a housing 402 having a plurality of buttons. For example, the remote control device 206 can include a power button 404, an IPTV button 406, a television (TV) button 408, a digital video disc (DVD) button 410, and an auxiliary (AUX) button 412. When the IPTV button 406 is pressed, the remote control device 206 can be used to control an IPTV receiver. When the TV button 408 is pressed, the remote control device 406 can be used to control a TV connected to the IPTV receiver. When the DVD button 410 is pressed, the remote control device 206 can be used to control a DVD player connected to the TV, the IPTV receiver, or both. Additionally, when the AUX button 412 is pressed, the remote control device 206 can be used to control an auxiliary device connected to the TV, the IPTV receiver, or both. For example, the auxiliary device can be a compact disc (CD) player, a video cassette recorder (VCR), an audio receiver, or some other home entertainment device.

The remote control device 206 can include a TV/VIDEO button 414 that can be used to toggle between television content and video content, e.g., from a DVD player. The remote control device 206 can also include a PLAY button 416, a PAUSE button 418, a STOP button 420, a RECORD button 422, a rewind (REW)/fast forward (FF) button 424, and a replay/slow forward (FWD) button 426. These buttons can be used to control the content received at the IPTV receiver or video content received from a DVD player. One or more of these buttons can also be programmed to control a CD player, a VCR, or some other home entertainment device.

The remote control device 206 can also include a VIDEO ON DEMAND button 428 and a RECORDED TV button 430. The VIDEO ON DEMAND button 428 can be pressed in order to access on demand video content available via the IPTV receiver. The RECORDED TV button 430 can be pressed in order to access television content recorded at the IPTV receiver.

The remote control device 206 can also include a MENU button 432, a BACK button 434, a GO INTERACTIVE button 436, an EXIT button 438, and an INFO button 440. The MENU button 432 can be used to access a menu of features provided by the IPTV receiver. Further, the INFO button 440 can be used to access an information window provided by the IPTV receiver. The GO INTERACTIVE button 436 can be used to access interactive content provided by the IPTV system. FIG. 4 also shows that the remote control device 206 can include a directional keypad 442. The directional keypad 442, the BACK button 434, and the EXIT button 438 can be used to navigate within the various content windows provided by the IPTV receiver. The remote control device 206 can also include a triangular A button 444, a square B button 446, and a round C button 448. The A button 444, the B button 446, and the C button 448 can be used to make various selections when navigating within a menu screen, an information screen, or some other screen provided by the IPTV receiver.

The remote control device 206 can further include a GUIDE button 450 that can be pressed in order to access a guide for the content provided by the IPTV receiver. Moreover, the remote control device 206 can include a volume (VOL) up/down button 452, a MUTE button 454, a channel/page (CH/PG) up/down button 456, and a LAST button 458. The VOL button 452 can be used to control the volume of an IPTV receiver, a TV, a CD player, etc. The MUTE button 454 can be used to mute audio content provided by an IPTV receiver, a TV, a CD player, etc. The CH/PG button 456 can be used to change the channel at an IPTV receiver or navigate from page-to-page within a content guide provided by an IPTV receiver. The LAST button 458 can be used to return to the last channel viewed by the user at the IPTV receiver.

The remote control device 206 can include a numerical keypad 460 having a plurality of buttons that are individually numbered 1, 2, 3, 4, 5, 6, 7, 8, 9, and 0. The numerical keypad 460 is configured similar to a telephone keypad and each individual button also includes a portion of the alphabet. The 2 button includes ABC, the 3 button includes DEF, the 4 button includes GHI, the 5 button includes JKL, the 6 button includes MNO, the 7 button includes PQRS, the 8 button includes TUV, and the 9 button includes WXYZ. The 0 button can also be used as a SPACE button. In a particular embodiment, the numerical keypad 460 can be used to input a specific channel number. Further, the numerical keypad 460 can be used to input text to the IPTV system, when necessary, using the triple tap method well known in the art. The numerical keypad 460 can also include a DELETE button 462 and an ENTER/ZOOM button 464.

The remote control device 206 can also include a TEXT button 466 and a SEND button 468. These buttons can be used to send and receive text messages via an IPTV system and IPTV receiver. Further, the remote control device 206 can include a microphone 470 incorporated therein. A user can speak into the microphone 470 at the remote control device 206 and that audio can be transmitted to an IPTV receiver. The IPTV receiver can include speech-to-text software that can translate the speech directly to text. As such, the microphone 470 at the remote control device 206 can be used to capture text messages to be sent via the IPTV receiver.

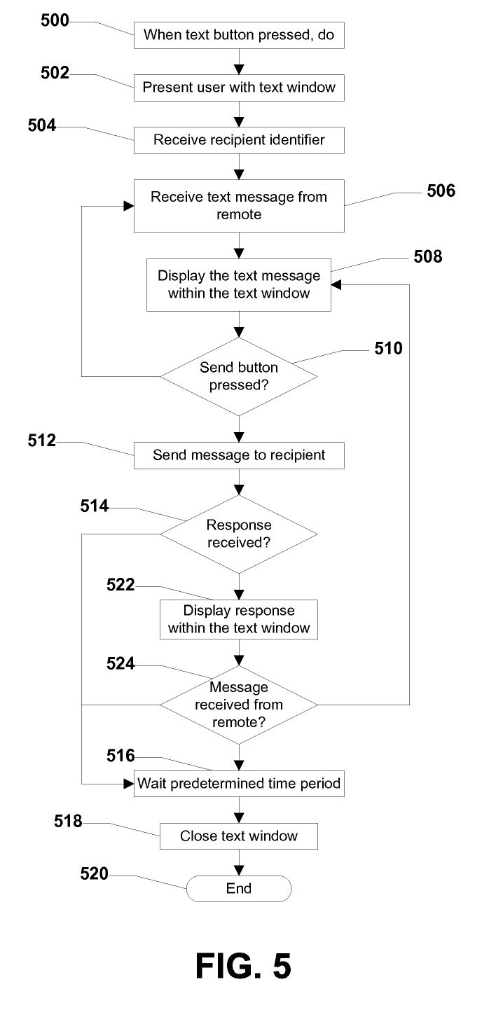

FIG. 5 shows a method of sending text messages from an IPTV receiver and an IPTV remote control device is shown and commences at block 500. At block 500, when a text button on the IPTV remote control device is pressed by a user, a do loop is entered and the following steps are performed. At block 502, the user can be presented with a text window at a display device connected to the IPTV receiver. At block 504, the IPTV receiver can receive a recipient identifier. The recipient identifier can be a recipient's name that corresponds to a unique IP address, a unique wireless telephone number, a unique POTS telephone number, or some other unique identifier.

At block 506, a text message can be received at the IPTV receiver from the IPTV remote control device and at block 508, the text message can be displayed within the text window. In a particular embodiment, the user can use the “triple tap” method to create a text message at the text window presented by the IPTV receiver. In other words, the user can use the numerical keypad at the IPTV remote control device to create a text message.

Conversely, the user can speak into a microphone within the IPTV remote control device. The IPTV remote control device can transmit the voice data, real time, to the IPTV receiver. The IPTV receiver can use a speech-to-text application embedded within the IPTV receiver to translate the voice date to text data. The text data, corresponding to the voice data, can be displayed within the text window at the display device. [00

Proceeding to decision step 510, the IPTV receiver can determine whether a send button at the IPTV remote control device is pressed. If the send button is not pressed, the method can return to block 506 and continue as described herein. On the other hand, when the IPTV receiver detects that the send button is pressed at the IPTV remote control device, the method can move to block 512 and the text message can be sent to the recipient designated above.

Moving to decision step 514, the ITPV receiver can determine whether a response to the text message is received. If not, the method can proceed to block 516. At block 516, the IPTV receiver can wait a predetermined time period for a response. Thereafter, the IPTV receiver can close the text window at block 518. Then, at state 520, the method can end.

Returning to decision step 514, if a response is received at the IPTV receiver, the method can continue to block 522 and the response can be displayed within the text window. At decision step 524, the IPTV receiver can determine whether an additional text message is received from the ITPV remote control device. If so, the method can return to block 508 and continue as described herein. Otherwise, the method can move to block 516 and continue as described.

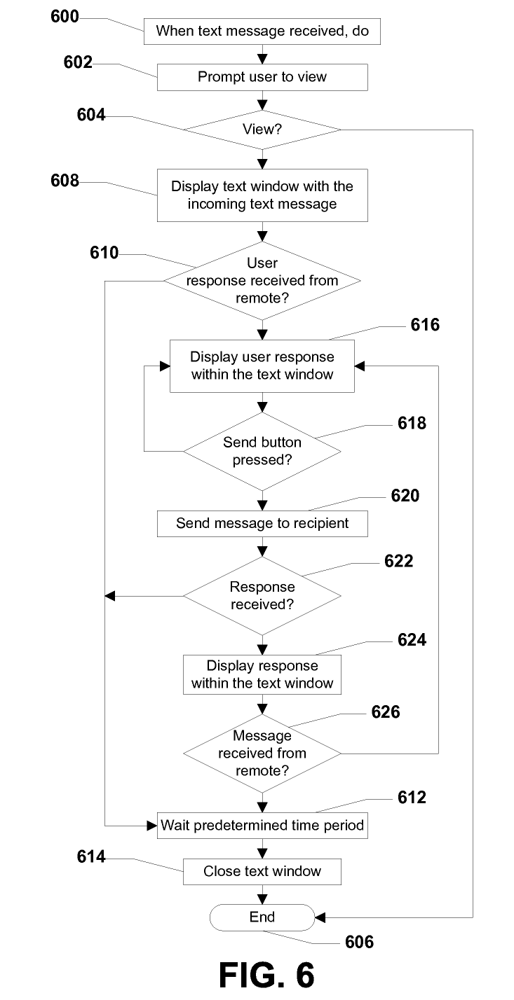

FIG. 6 illustrates a method for receive text messages at an IPTV receiver. Beginning at block 600, when a text message is received at the IPTV receiver, the following steps are performed. At block 602, the user is prompted to view the text message. At decision step, the IPTV receiver receives an indication of whether the user wishes to view the text message. If the user does not want to view the text message, the method can end at state 606.

Returning to decision step 604, if the user wishes to view the text message, the method can move to block 608 and the IPTV receiver can display a text window with the incoming text message. Moreover, at decision step 610, the IPTV receiver can determine whether a user response to the incoming text message is received from the IPTV remote control device. If a user response is not received, the method can move to block 612 and the IPTV receiver can wait a predetermined time period before closing the text window at block 614. Thereafter, the method can end at state 606.

At decision step 610, when a user response to the incoming text message is received at the IPTV receiver, the method can move to block 616 and the user response can be displayed in the text window. Moving to decision step 618, the IPTV receiver can determine whether the send button at the IPTV remote control is pressed. If the send button is not pressed, the method can return to block 616 and continue as described herein. On the other hand, when the IPTV receiver detects that the send button is pressed at the IPTV remote control device, the method can move to block 620 and the text message can be sent to the initiator of the text message conversation.

Moving to decision step 622, the ITPV receiver can determine whether a response to the text message is received. If not, the method can proceed to block 612 and continue as described herein. Conversely, if a response is received at the IPTV receiver, the method can continue to block 624 and the response can be displayed within the text window. At decision step 626, the IPTV receiver can determine whether an additional text message is received from the ITPV remote control device. If so, the method can return to block 616 and continue as described herein. Otherwise, the method can move to block 612 and continue as described.

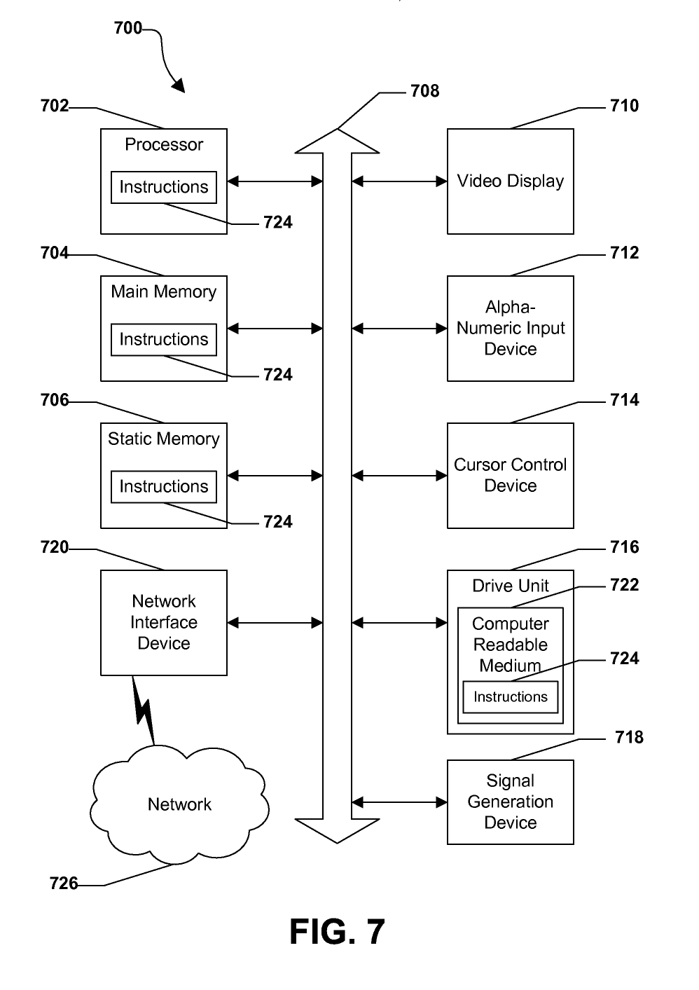

Referring to FIG. 7, an illustrative embodiment of a general computer system is shown and is designated 700. The computer system 700 can include a set of instructions that can be executed to cause the computer system 700 to perform any one or more of the methods or computer based functions disclosed herein. The computer system 700 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 700 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 700 can be implemented using electronic devices that provide voice, video or data communication. Further, while a single computer system 700 is illustrated, the term “system” shall also be taken to include any collection of systems or sub-systems that individually or jointly execute a set, or multiple sets, of instructions to perform one or more computer functions.

As illustrated in FIG. 7, the computer system 700 may include a processor 702, e.g., a central processing unit (CPU), a graphics processing unit (GPU), or both. Moreover, the computer system 700 can include a main memory 704 and a static memory 706 that can communicate with each other via a bus 708. As shown, the computer system 700 may further include a video display unit 710, such as a liquid crystal display (LCD), an organic light emitting diode (OLED), a flat panel display, a solid state display, or a cathode ray tube (CRT). Additionally, the computer system 700 may include an input device 712, such as a keyboard, and a cursor control device 714, such as a mouse. The computer system 700 can also include a disk drive unit 716, a signal generation device 718, such as a speaker or remote control, and a network interface device 720.

In a particular embodiment, as depicted in FIG. 7, the disk drive unit 716 may include a computer-readable medium 722 in which one or more sets of instructions 724, e.g. software, can be embedded. Further, the instructions 724 may embody one or more of the methods or logic as described herein. In a particular embodiment, the instructions 724 may reside completely, or at least partially, within the main memory 704, the static memory 706, and/or within the processor 702 during execution by the computer system 700. The main memory 704 and the processor 702 also may include computer-readable media. The network interface device 720 can provide connectivity to a network 726, e.g., a wide area network (WAN), a local area network (LAN), or other network.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 724 or receives and executes instructions 724 responsive to a propagated signal, so that a device connected to a network 726 can communicate voice, video or data over the network 726. Further, the instructions 724 may be transmitted or received over the network 726 via the network interface device 720.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

### Conclusion

With the configuration of structure described herein, one or more embodiments herein provide a way to send and receive text messages via a set top box. Further, one or more embodiments provide a way to input text messages via a numerical keypad, a virtual keyboard, via voice data, or a combination thereof. A virtual keyboard provided herein is substantially transparent and as such, minimizes blocking of video content when displayed. A text window is also substantially transparent and minimizes the blocking of video content when displayed.

Furthermore, embodiments herein can use the equipment provided by an IPTV system to send and receive messages. For example, the messages can be sent and received via a residential gateway, a set top box (i.e., an ITPV receiver), and a remote control device. Further, the messages can be transmitted via a twisted pair to and from the user's premises. Embodiments herein can allow messages to be sent between set top boxes in separate customer locations, between set top boxes in a single customer location (i.e., between set top boxes in different rooms within a customer domicile), and between a set top box and a wireless device, e.g., a cell phone, a portable data assistant, etc.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the FIGS. are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description of the Drawings, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description of the Drawings, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosed subject matter. Thus, to the maximum extent allowed by law, the scope of the present disclosed subject matter is to be determined by the broadest permissible interpretation of the following claims and their equivalents, and shall not be restricted or limited by the foregoing detailed description.

What is claimed is:

1. A method for sending text messages from an IPTV receiver, the method comprising:
detecting that a text button is pressed at an IPTV remote control device associated with the IPTV receiver; and
displaying a text window at a display device coupled to the IPTV receiver.

2. The method of claim 1, wherein the text window is picture-in-picture window.

3. The method of claim 1, wherein the text window is an L-bar that partially surrounds a video content window.

4. The method of claim 1, wherein the text window is a substantially clear window that overlays video content.

5. The method of claim 1, further comprising:
displaying a virtual keyboard at the display device.

6. The method of claim 5, wherein the virtual keyboard is substantially clear and overlays video content.

7. The method of claim 1, further comprising:
receiving a recipient identifier within the text window.

8. The method of claim 3, further comprising:
receiving a text message.

9. The method of claim 8, wherein the text message is received from the IPTV remote control device.

10. The method of claim 9, wherein the text message is received as voice data and converted to text within the IPTV receiver.

11. The method of claim 8, further comprising:
displaying the text message within the text window.

12. The method of claim 11, further comprising:
transmitting the text message to the recipient when a send button is pressed.

13. An IPTV receiver, comprising:
a processor;
a memory coupled to the processor; and
a computer program within the memory, wherein the computer program includes logic to:
detect when a text button is pressed at an IPTV remote control device associated with the IPTV receiver; and
display a text window at a display device coupled to the IPTV receiver.

14. The IPTV receiver of claim 13, wherein the computer program further comprises logic to:
receive a recipient identifier within the text window.

15. The IPTV receiver of claim 14, wherein the computer program further comprises logic to:
receive a text message at the ITPV receiver.

16. The IPTV receiver of claim 13, wherein the computer program further comprises logic to:
receive voice data from the IPTV remote control device; and
convert the voice data to text.

17. The IPTV receiver of claim 16, wherein the computer program further comprises logic to:
display the text message within the text window; and
transmit the text message to the recipient when a send button is pressed.

18. A graphical user interface (GUI) for sending text via an IPTV receiver, the GUI comprising:
a text window for viewing text messages, wherein the text window is displayed at a display device coupled to the IPTV receiver; and
a virtual keyboard, wherein the virtual keyboard is displayed at the display device.

19. The GUI of claim 18, wherein the text window comprises:
a transparent window that overlays video content; and
opaque text within the transparent window, wherein the opaque text represents one or more text messages sent from or received at the IPTV receiver.

20. The GUI of claim 18, wherein the virtual keyboard comprises:
a plurality of clear buttons, wherein each button is surrounded by an opaque border and wherein each button includes an opaque identifier.
